(19) United States
(12) Patent Application Publication
(10) Pub. No.: US 2013/0036740 A1
(43) Pub. Date: Feb. 14, 2013

(54) MULTI-FUEL INJECTION NOZZLE

(71) Applicants: Ulrich Woerz, Oviedo, FL (US); Jianfan Wu, Orlando, FL (US)

(72) Inventors: Ulrich Woerz, Oviedo, FL (US); Jianfan Wu, Orlando, FL (US)

(21) Appl. No.: 13/205,702

(22) Filed: Aug. 9, 2011

(51) Int. Cl. F02C 7/22; B21D 53/00

(52) U.S. Cl. 60/740; 29/890.02

(57) ABSTRACT

A multi-fuel nozzle (90) for a gas turbine engine. The nozzle includes: an annular main body (68) having a plurality of fuel gas channels (22), all disposed circumferentially about a main body longitudinal axis (14); an annular fuel oil body (30) disposed within the annular main body (68) and having a central oil channel (36) coaxial with the main body longitudinal axis (14); an annular cooling air channel (42) between the annular main body (68) and the fuel oil body (30); a discrete cooling air body (70, 100) having a guide (74, 104), the guide (74, 104) supported independent of a downstream end (84) of the main body (68) and configured to direct cooling air traveling downstream in the annular cooling air channel (42) radially inward at a location immediately downstream of a central oil channel downstream end (34).

### FIELD OF THE INVENTION

The invention relates to an improved multi-fuel nozzle for a gas turbine engine. In particular, this invention relates to an improved design for a cooling air guide in the multi-fuel nozzle.

### BACKGROUND OF THE INVENTION

Certain multi-fuel nozzles used in turbine engines inject a fuel gas and a fuel oil into the combustor. If nozzle surfaces in and around the fuel oil outlet are not cooled, over time combustion of the fuel gas and fuel oil generates enough heat to coke the fuel oil onto the surfaces. Conventionally these surfaces have been thermally isolated from the combustion heat by directing cooling air toward the fuel oil outlet between the surfaces and the combustion flame. The cooling air is usually generated by the compressor of the turbine engine, and consequently the cooling air is at an elevated temperature. The cooling air is typically directed by a guide, and the guide is integral to a main body that also delivers the fuel gas. The fuel gas is conventionally at a temperature that is much closer to ambient temperature. As a result of this thermal mismatch in the main body, there is uneven thermal growth of the main body. This uneven thermal growth produces internal stress in the main body which, over time, manifests as cracks that may shorten the service life of the main body, and therefore the nozzle.

### BRIEF DESCRIPTION OF THE DRAWINGS

The invention is explained in the following description in view of the drawings that show:

FIG. 1 is a cross section of a multi-fuel injection nozzle of the prior art.

FIG. 2 is an end view of a downstream face of the prior art multi-fuel injection nozzle of FIG. 1 with cracks.

FIG. 3 shows a repaired downstream face of the prior art multi-fuel injection nozzle of FIG. 2.

FIG. 4 shows a main body of an improved multi-fuel injection nozzle main body.

FIG. 5 shows a first embodiment of the improved multi-fuel injection nozzle.

FIG. 6 shows a sleeved cooling air body.

FIG. 7 shows a second embodiment of the improved multi-fuel injection nozzle.

FIG. 8 shows a ringed cooling air body

FIG. 8 shows a close-up view of the ringed cooling air body as attached to an outer portion of the fuel oil body downstream end.

FIG. 9 shows another angle of the cooling air body of FIG. 8.

FIG. 10 shows another angle of the cooling air body of FIG. 8.

### DETAILED DESCRIPTION OF THE INVENTION

A multi-fuel injection nozzle for a turbine engine configured to inject a fuel oil into a combustor may experience coking of the fuel oil on surfaces about an outlet of the fuel oil due to heat from the combustion flame. One way to reduce or eliminate this coking is to cool those surfaces using a cooling fluid. Air from a combustor has been used as the cooling fluid. Cooling air from the compressor may be at an elevated temperature, for example about 450° C. However, one or both of the fuels also delivered by the multi-fuel nozzle may be at or near ambient temperature, such as approximately 20° C. In some nozzles the guide that directs the cooling air is integral to a body of the nozzle that also delivers at least one of the fuels. Since the cooling air that is at a relatively elevated temperature and the fuel that is at a relatively cool temperature are in contact with that body there is a thermal gradient within that body. As a result the body experiences stress related to relative thermal growths within the body. Over time this stress may manifest as a crack or cracks in the body. Conventional repairs require that the nozzle be removed and sent off-site for repair. Consequently, these repairs are costly in terms of a cost of the parts, a cost of labor, down time, and customer dissatisfaction if the scrapped part had not reached its predicted service life.

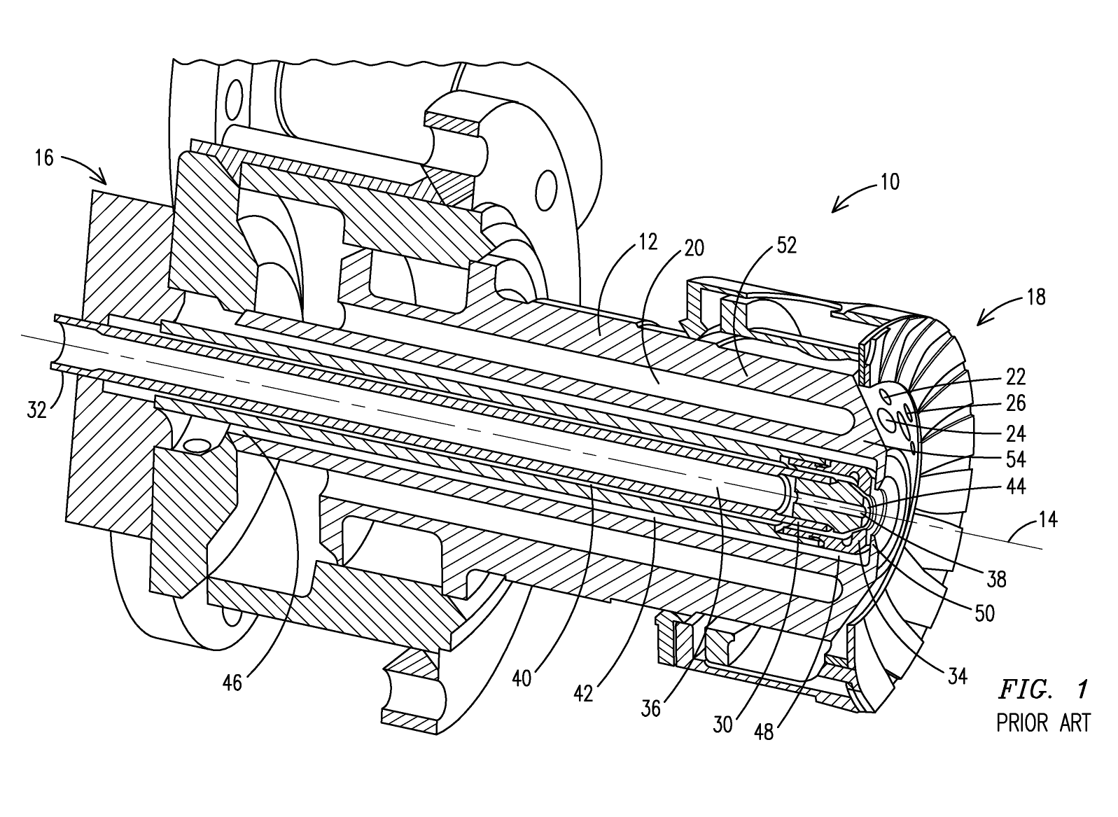

The inventors have devised an innovative solution that will reduce or eliminate the formation of these cracks. Specifically, the inventors have ascertained that thermally isolating the cooling air guide from the body that delivers relatively cool fuel may reduce or eliminate the thermal gradient and associated thermal stresses within the multi-fuel nozzle. One example of such a prior art nozzle susceptible to this condition is a Siemens DF42 steam injection nozzle 10 (original nozzle) shown in FIG. 1. The original nozzle 10 comprises an annular original main body 12 comprising a main body longitudinal axis 14, a main body upstream end 16 and an original main body downstream end 18. A plurality of steam injection channels 20 and a plurality of fuel gas channels 22 are disposed in the original main body 12 circumferentially about the main body longitudinal axis 14. Each steam injection channel 20 ends at the original main body downstream end 18 at a steam injection channel outlet 24. Likewise, each fuel gas channel 22 ends at an original main body downstream end 18 at a fuel gas channel outlet 26.

Within and concentric with the original main body is an annular fuel oil body 30 comprising a fuel oil body upstream end 32 and a fuel oil body downstream end 34. The fuel oil body 30 comprises a central fuel oil channel 36 comprising a central fuel oil channel outlet 38 at the fuel oil body downstream end 34. A multi-purpose annular channel 40 is disposed about the central fuel oil channel 36. The multi-purpose channel 40 may deliver NOx reducing water during normal operation, and may deliver atomization air during ignition. Disposed between the original main body 12 and the fuel oil body 30 is an annular cooling air channel 42 for delivering cooling air from a compressor (not shown) to surfaces 44 adjacent to the central fuel oil channel outlet 38.

The cooling air travels from an upstream end 46 of the cooling air channel 42 to a downstream end 48 of the cooling air channel 42, wherein it encounters an original cooling air guide 50. The original cooling air guide 50 in existing DF42 nozzles is integral to the original annular main body 12. In operation, the original cooling air guide 50 directs the cooling air radially inward into a flow of fuel oil exiting the central fuel oil channel outlet 38. The cooling air forms a protective layer between the surfaces 44 adjacent to the central fuel oil channel outlet 38 and heat generated by combustion downstream of the central fuel oil channel outlet 38. However, relative to the fuel gas that is flowing through the fuel gas channels 22, the cooling air contacting the original guide 50 is significantly hotter. As a result, a relatively cool region 52 of the original main body 12 proximate the fuel gas channels 22 is in contact with relatively cool fuel gas, while a relatively hot region 54 of the original main body 12 proximate the guide 50 is in contact with relatively hot air. This thermal gradient causes stress and uneven thermal growth in the original main body downstream end 18, which may result in cracks.

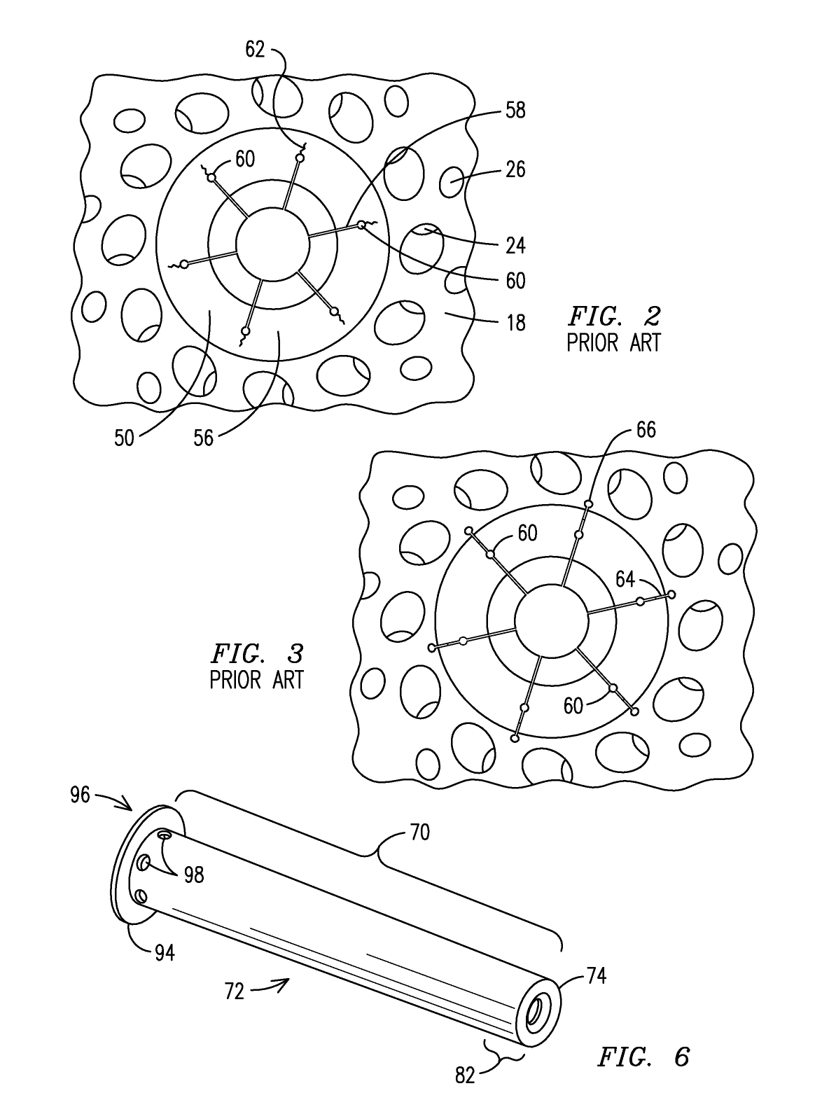

FIG. 2 shows an end view of the original main body downstream end 18, comprising steam injection channel outlets 24 and fuel gas channel outlets 26, and a combustion side 56 of the guide 50. Not shown is the fuel oil body 30. Original stress relief slits 58 and original stress relief holes 60 may be machined into the original main body downstream end 18 to account for the stress resulting from the thermal gradient. However, over time these may not suffice and stress cracks 62 may form at the stress relief holes 60. As shown in FIG. 3, a conventional repair method comprises machining a new stress relief slit 64 where the crack (not show) was, and machining a new stress relief hole 66 at an end of the new stress relief slit 64. This repair will extend the life of the annular main body 12, and thus the nozzle 10. However, this repair can only be performed once, and experience shows that cracks may appear at the new stress relief hole 66 similar to how they appears at the original stress relief holes 60. Once this happens, the original main body 12 can no longer be repaired and must be replaced.

In order to prevent the cracks the inventors discovered a way to alleviate the cause of the cracks, which is the large thermal gradient through the annular main body 12. The inventors have devised a way to thermally isolate the guide 50 from the original main body 12 so that the original main body 12 is not simultaneously in contact with ambient temperature fuel gas and relatively hot air. The inventors have altered the structure of the original nozzle 10 so that a new main body 68 no longer supports the original guide 50. Instead, the new guide (not shown) finds support elsewhere in a new nozzle. FIG. 4 shows the new main body 68, without the original fuel oil body, where the new annular main body 68 is devoid of the original guide 50. The new main body 68 may be manufactured without the original guide 50, or may be fabricated from an original main body 12 by removing the original guide 50 from the original main body 12, thereby forming the new main body 68. Without the thermal stress induced by the presence of the original guide 50, the new main body 68 is less susceptible to thermally induced cracks.

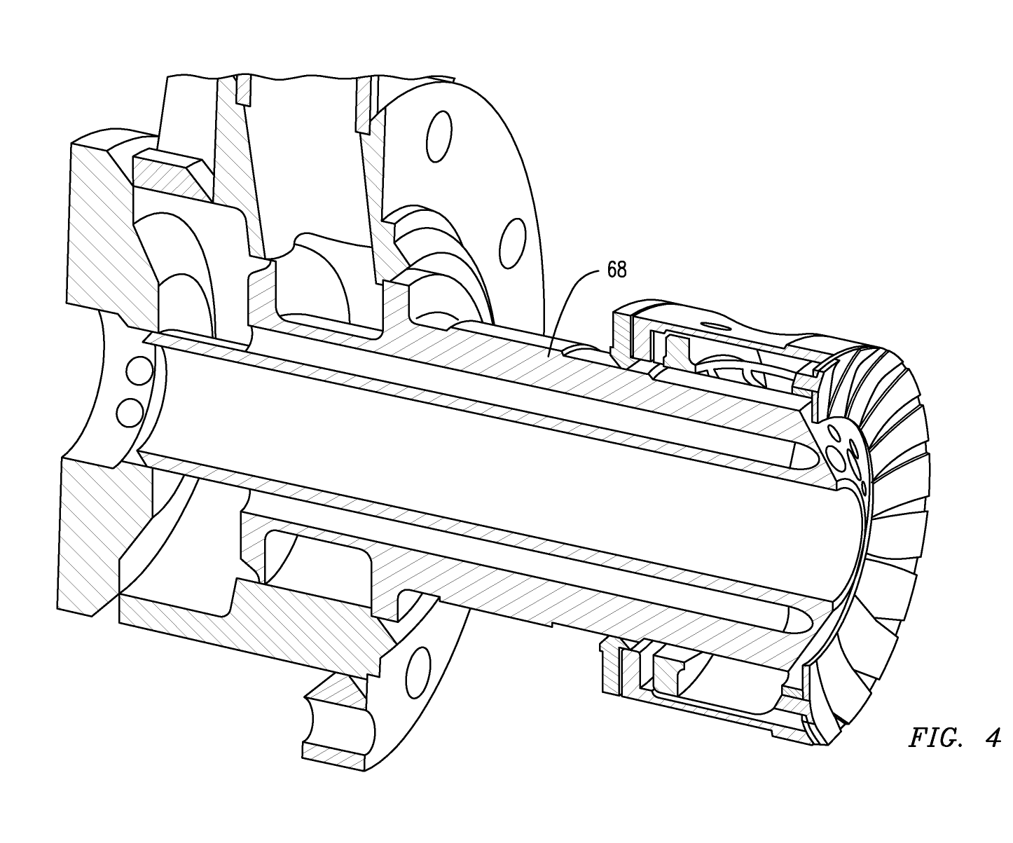

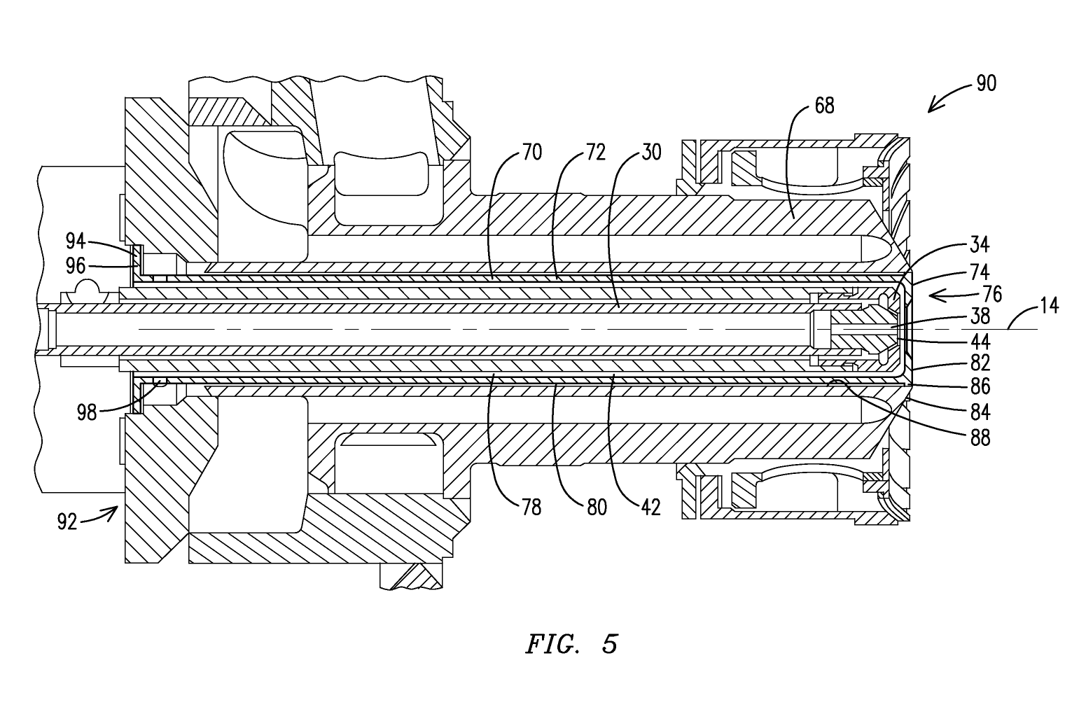

The new guide may be supported in any number of ways. In and embodiment the guide is part of a separate cooling air body, and the cooling air body is supported elsewhere in the nozzle. In one embodiment shown in FIG. 5, a sleeved cooling air body 70 comprises an annular sleeve 72 and a new guide 74 disposed at a downstream end 76 of the sleeve 72. At least a part of the sleeve 72 is disposed in the cooling air channel 42, and the sleeve 72 is configured to position the new guide 74 in approximately the same location as the original guide 50. The position need not be exactly the same, so long as the new guide 74 properly directs air radially inward sufficient to minimize or eliminate coking on the surfaces adjacent the surfaces 44 adjacent to the central fuel oil channel outlet 38. Further, the downstream face of the new nozzle 90 will have a similar geometry as the original nozzle 10, which is important to ensure no changes in the operation of the nozzle. The new geometry need not be exactly the same, but should be close enough to produce similar combustion characteristics as the original nozzle 10. The sleeve 72 forms a sleeve inner cooling air channel 78 between the sleeve 72 and the fuel oil body 30. During operation cooling air will flow in the inner cooling air channel 78 until it reaches the new guide 74, wherein the new guide 74 directs the cooling air radially inward in a manner similar to how the original guide 50 did. The sleeve 72 may also form a sleeve outer cooling air channel 80 between the sleeve 72 and the new main body 68. A downstream end 82 of the sleeved cooling air body 70 may be slip fit into a downstream end 84 of the new main body 68. This may be accomplished by a raised ridge 86 disposed at a downstream end 76 of the sleeve 72 and in contact with an annular inner surface 88 of the new main body 68. The raised ridge 86 may take any shape, including a continuous ridge, or a serrated or grooved ridge, and may be designed to let a portion of the cooling air pass between it and the inner surface 88 of the new main body 68. In operation cooling air may travel along the sleeve outer cooling air channel 80 until it reaches the raised ridge 86, where it may leak past the raised ridge 86 and into the combustor. Raised ridge 86 may serve to regulate the rate of flow of cooling fluid through the sleeve outer cooling air channel 80. If there is no raised ridge 86, the cooling air in the outer cooling air channel 80 will flow unrestricted out of the new nozzle 90.

In contrast to the original nozzle 12, during operation of the new nozzle 90 and in response to exposure to heated air, the new guide 74 is free to expand and move along the main body longitudinal axis 14 relative to the new main body downstream end 84 because the new guide 74 is no longer integral to the new main body downstream end 84. The sleeved cooling air body 70 is relatively thin and this allows it to heat and cool uniformly as well which contributes to thermal homogeneity and thus reduced thermal stress. The inability of the original guide 50 to move along the main body longitudinal axis 14 relative to the original main body downstream end 18 was at least one cause of the cracking, and with that restriction lifted due to the innovative design, the force that caused the cracks is reduced or eliminated altogether, thereby reducing or eliminating the cracks as well. In addition, in embodiments wherein cooling air can flow between the sleeve 72 and the new main body inner surface 88, the isolation of the new guide 74 from the new main body downstream end 84 is even greater, enhancing the crack reduction of the new design. Further, in this embodiment the new guide 74 is also free to move along the main body longitudinal axis 14 relative to the fuel oil body downstream end 34, which permits greater thermal isolation of the new guide 74.

In order to install the sleeved cooling air body 70 the fuel oil body 30 may be removed, and the sleeved cooling air body 70 installed. The sleeved cooling air body 70 may be supported at an upstream end 92 of the new main body 68 by methods known in the art, such as welding. The sleeved cooling air body 70 may include a flange 94 disposed at an upstream end 96 of the sleeved cooling air body 70. The flange 94 may be welded to the new nozzle 90 in any appropriate location. In an embodiment where cooling air is supplied from a point radially outward of the sleeve 72, the sleeve 72 may comprise sleeve apertures 98 to communicate the cooling air to the inner cooling air channel 78.

FIG. 6 shows an embodiment of the sleeved cooling air body 70 alone, comprising the sleeve 72, the new guide 74 connected to the sleeve 72 at the sleeved cooling air body downstream end 82, and a flange 94 connected to sleeve 72 at the sleeved cooling air body upstream end 96. The sleeve apertures 98 are also disposed at the sleeved cooling air body upstream end 96.

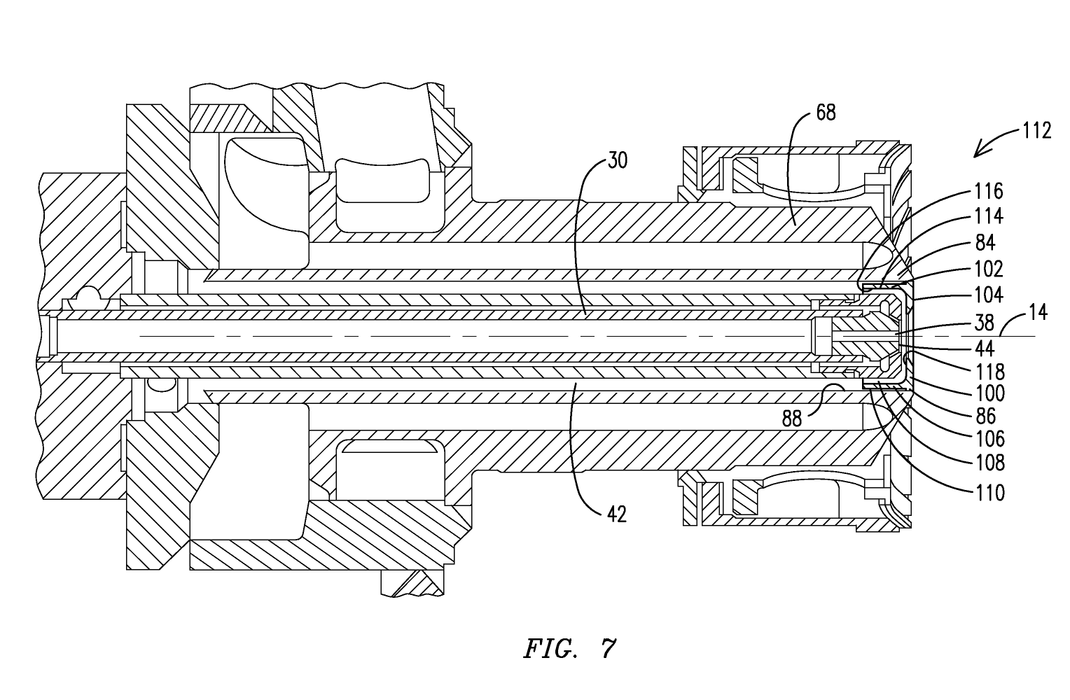

FIG. 7 shows a ringed cooling air body 100 comprising an annular ring 102 and a new guide 104 disposed at a downstream end 106 of the ring 102. At least a part of the ring 102 is disposed in the cooling air channel 42 and the ring 102 is configured to position the new guide 104 in approximately the same location as the original guide 50. The position need not be exactly the same, so long as the new guide 104 properly directs air radially inward sufficient to minimize or eliminate coking on the surfaces adjacent the surfaces 44 adjacent to the central fuel oil channel outlet 38. The ring 102 forms a ring inner cooling air channel 108 between the ring 102 and the fuel oil body 30. During operation cooling air will flow in the cooling air channel 42, and then the ring inner cooling air channel 108 until it reaches the new guide 104, wherein the new guide 104 directs the cooling air radially inward in a manner similar to how the original guide 50 did. Similar to an inner surface of the sleeved cooling air body 70, an inner surface 114 of the ringed cooling air body 100 is defined at least partly by an inner surface 116 of the ring 102 and an inner surface 118 of the new guide 104, and it is this surface that redirects the cooling air radially inward. Similar to the sleeved cooling air body 70, the ring downstream end 106 may comprise a raised ridge 86 in contact with the new main body inner surface 88. Likewise, the ring 102 may form a ring outer cooling air channel 110 between the ring 102 and the new main body inner surface 88. In operation cooling air may travel along the ring outer cooling air channel 110 until it reaches the raised ridge 86, where it may leak past the raised ridge 86 and into the combustor. Raised ridge 86 may serve to regulate the rate of flow of cooling fluid through the ring outer cooling air channel 110. If there is no raised ridge 86, the cooling air in the outer cooling air channel 80 will flow unrestricted out of the new nozzle 112.

In contrast to the prior art and similar to the sleeved cooling air body 70, during operation of the new nozzle 112 the new guide 104 is free to expand and move along the main body longitudinal axis 14 relative to the new main body downstream end 84 because the new guide 104 is no longer integral to the new main body downstream end 84. This freedom yields the same reduction in thermal stresses, and consequently reduces or eliminates thermal cracking.

In order to install the ringed cooling air body 100 the original guide 50 may be removed through techniques known in the art, such as machining etc. Then the ringed cooling air body 100 may be welded or otherwise attached to the fuel oil body 30 at a point upstream of the fuel oil body downstream end 34. This method of modifying the original nozzle 10 yields an advantage over the method that employs the sleeved cooling air body 70 because the ringed cooling air body 100 can be installed on the fuel oil body 30 when the fuel oil body 30 is in its assembled position. In contrast, installing the sleeved cooling air body 70 requires removing the fuel oil body 30, installing the sleeved cooling air body 70, and then reinstalling the fuel oil body 30.

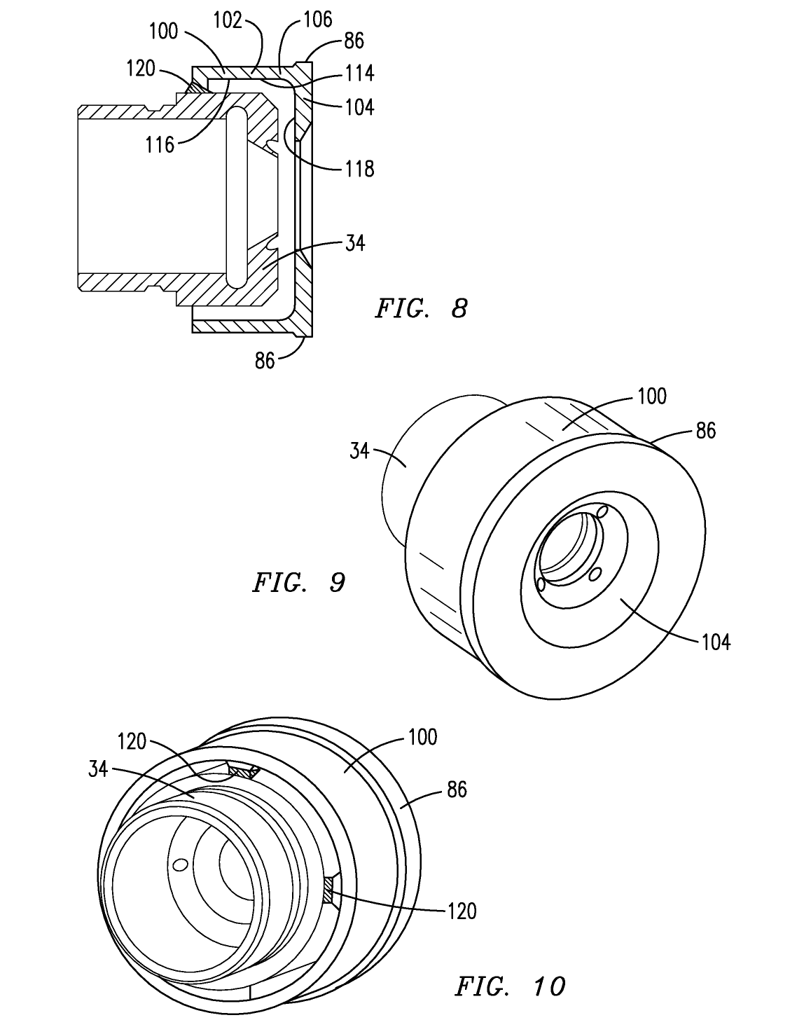

FIG. 8 shows a close-up view of the ringed cooling air body 100 as attached to an outer portion of the fuel oil body downstream end 34. The ringed cooling air body 100 comprises the ring 102, the new guide 104 disposed at the ring downstream end 106, the inner surface 114, the ring inner surface 116 and the new guide inner surface 118. Further, shown is one of a plurality of discrete weldments 120 which, in an embodiment, are used to support the ringed cooling air body 100. However, any number of ways of attaching the ringed cooling air body 100 are known to those in the art and may be used. FIG. 9 shows another angle of the ringed cooling air body 100 comprising the new guide 104. FIG. 10 also shows another angle of the ringed cooling air body 100 and two weldments 120.

It has been shown that the inventors have devised an innovative way to reduce or eliminate a thermal gradient that has caused cracking in existing dual fuel nozzle designs. With minimal changes new dual fuel nozzles can be manufactured to the new design and these new dual fuel nozzles will experience fewer thermally induced cracked, or no thermally induced cracks. Further, existing nozzles that use the integral guide can readily be upgraded to the new design. The new design will increase the life of the dual fuel nozzle, which will in turn reduce costs and increase customer satisfaction.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A multi-fuel nozzle for a gas turbine engine, comprising:
an annular main body comprising a plurality of fuel gas channels, all disposed circumferentially about a main body longitudinal axis;
an annular fuel oil body disposed within the annular main body and comprising a central oil channel coaxial with the main body longitudinal axis;
an annular cooling air channel between the annular main body and the fuel oil body; and
a discrete cooling air body comprising a guide, the guide supported independent of a downstream end of the main body and configured to direct cooling air traveling downstream in the annular cooling air channel radially inward at a location immediately downstream of a central oil channel downstream end, wherein the guide is free to move along the main body longitudinal axis relative to the main body downstream end during relative axial thermal expansion and contraction of the main body.

2. The multi-fuel nozzle for a gas turbine engine of claim 1, wherein the cooling air body comprises an annular sleeve extending axially upstream from the guide and through the annular cooling air channel, wherein the cooling air body comprises the guide at a downstream end of the sleeve, and wherein an upstream end of the sleeve is supported in a manner that permits the guide to move along the main body longitudinal axis with respect to the central oil channel downstream end during axial thermal expansion and contraction of the fuel oil body with respect to the cooling air body.

3. The multi-fuel nozzle for a gas turbine engine of claim 2, wherein the upstream end of the sleeve is supported at an upstream end of the multi-fuel nozzle.

4. The multi-fuel nozzle for a gas turbine engine of claim 2, wherein the downstream end of the sleeve comprises a raised ridge that slip-fits inside the downstream end of the annular main body and thereby positions the guide radially.

5. The multi-fuel nozzle for a gas turbine engine of claim 4, wherein the raised ridge is configured to leak a portion of the cooling air between the raised ridge and the annular main body.

6. The multi-fuel nozzle for a gas turbine engine of claim 2, wherein the sleeve divides the annular cooling air channel into an inner annular cooling air channel portion between the fuel oil body and the sleeve, and an outer annular cooling air channel portion between the sleeve and the annular main body.

7. The multi-fuel nozzle for a gas turbine engine of claim 1, wherein the cooling air body comprises an annular ring extending axially upstream from the guide and into the annular cooling air channel, wherein the guide is disposed at a downstream end of the annular ring, and wherein the annular ring is supported at a fuel body downstream end and is spaced apart from the fuel body downstream end to define an annular gap between the annular ring and the fuel oil body to pass the cooling air from the cooling air channel.

8. The multi-fuel nozzle for a gas turbine engine of claim 7, wherein the annular ring comprises a raised ridge that slip-fits inside the downstream end of the annular main body and thereby radially positions the guide.

9. The multi-fuel nozzle for a gas turbine engine of claim 8, wherein the raised ridge is serrated to permit a portion of the cooling air to pass between the raised ridge and the annular main body.

10. The multi-fuel nozzle for a gas turbine engine of claim 7, wherein the annular ring is attached to the fuel body downstream end by discrete weldments.

11. The multi-fuel nozzle for a gas turbine engine of claim 10, wherein the annular ring defines a portion of an annular gap between the annular ring and the annular main body.

12. The multi-fuel nozzle for a gas turbine engine of claim 7, wherein the annular ring and the guide define an annular inner surface oriented radially inward at a downstream end of the cooling air body.

13. A method of modifying a dual-fuel nozzle for a gas turbine engine, wherein the dual-fuel nozzle comprises: an annular main body comprising a plurality of fuel gas channels, all disposed circumferentially about a main body longitudinal axis, and an integrally formed cooling air guide; a fuel oil body disposed within the main body and comprising a central oil channel coaxial with the main body longitudinal axis; and an annular cooling air channel between the annular main body and the fuel oil body, wherein the integral cooling air guide directs cooling air from the annular cooling air channel radially inward at a location immediately downstream of a central oil channel downstream end, the method comprising:
removing the integral cooling air guide; and
installing a discrete cooling air body comprising a new guide such that a downstream end of the main body is free to thermally expand and contract along the main body longitudinal axis with respect to the new guide, wherein the new guide is supported independent of a downstream end of the central oil channel.

14. The method of claim 13, wherein the cooling air body comprises an annular sleeve comprising at least a portion disposed in the annular cooling air channel and comprising the new guide disposed at a downstream end of the cooling air body, the method comprising fixing the sleeve such that the new guide is free to move axially with respect to the central oil channel downstream end during axial thermal expansion and contraction of the cooling air body with respect to the fuel oil body.

15. The method of claim 14, comprising removing the fuel oil body from the main body, installing the sleeve in the annular cooling air channel, and replacing the fuel oil body.

16. The method of claim 13, wherein the discrete cooling air body comprises an annular ring comprising the new guide at a downstream end of the annular ring, wherein the annular ring is supported by a fuel oil body downstream end and is spaced apart from the fuel oil body downstream end to define an annular gap between the annular ring and the fuel oil body to pass the cooling air from the cooling air channel.

17. The method of claim 16, wherein the cooling air body is supported by the fuel oil body downstream end while the fuel oil body is disposed inside the main body.
